(19) United States
(12) Patent Application Publication
(10) Pub. No.: US 2025/0154666 A1
(43) Pub. Date: May 15, 2025

(54) METHODS AND SYSTEMS FOR PRODUCING ETHYLENE FROM METHANE, AND RELATED ELECTROCHEMICAL CELLS

(71) Applicant: Battelle Energy Alliance, LLC, Idaho Falls, ID (US)

(72) Inventors: Lucun Wang, Idaho Falls, ID (US); Yuqing Meng, Ammon, ID (US); Dong Ding, Idaho Falls, ID (US)

(21) Appl. No.: 18/946,789

(22) Filed: Nov. 13, 2024

Related U.S. Application Data
(60) Provisional application No. 63/598,795, filed on Nov. 14, 2023.

(51) Int. Cl. C25B 3/03; B01J 23/00; B01J 23/10; C25B 3/23; C25B 11/077

(52) U.S. Cl. CPC C25B 3/03; B01J 23/002; B01J 23/10; C25B 3/23; C25B 11/0773

(57) ABSTRACT

A method of forming ethylene is disclosed. The method includes introducing oxygen-containing molecules to a first electrode of an electrochemical cell including the first electrode, a second electrode, and an electrolyte between the first electrode and the second electrode. The second electrode includes at least one catalyst material formulated to accelerate oxidative coupling of methane (CH₄) (OCM) reaction rates to produce C₂H₄ from CH₄ and oxygen ions. The method further includes introducing CH₄ to the second electrode of the electrochemical cell. The method also includes applying a potential difference in electrolysis mode between the first electrode and the second electrode of the electrochemical cell. The oxygen-containing molecules interact with the second electrode to produce O²⁻ through reduction of the oxygen-containing molecules, the O²⁻ are transported through the electrolyte, and C₂H₄ is produced at the second electrode through OCM. A system and an electrochemical cell for producing ethylene are also disclosed.

### CROSS-REFERENCE TO RELATED APPLICATION

This application claims the benefit under 35 U.S.C. § 119(e) of U.S. Provisional Patent Application Ser. No. 63/598,795, filed Nov. 14, 2023, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure, in various embodiments, relates to methods and systems for producing ethylene (C₂H₄) through oxidative coupling of methane (CH₄), and to associated electrochemical cells.

### BACKGROUND

Light olefins, such as ethylene (C₂H₄), propylene (C₃H₆), and butylene (C₄H₈), are major building blocks in manufacturing polymers, chemical intermediates, and solvents. Currently, light olefins are mainly produced by steam cracking of fossil-based feedstocks including naphtha and natural gases, which is known to be highly energy intensive and responsible for CO₂ emissions. In addition, conventional steam cracking processes require the use of complicated and costly systems and methods to purify (e.g., refine) the resulting olefin product.

Oxidative coupling of methane (OCM) to higher hydrocarbons, including ethylene (C₂H₄), has been considered a promising alternative approach for C₂H₄ production and upgrading of natural gas. However, conventional OCM to form C₂H₄ is hindered by a low methane conversion at relatively low temperatures and low selectivity of C₂H₄ resulting from the over-oxidation of methane.

### BRIEF SUMMARY

Embodiments of the disclosure include a method of forming ethylene (C₂H₄). The method includes introducing oxygen-containing molecules to a first electrode of an electrochemical cell that comprises the first electrode, a second electrode, and an electrolyte between the positive electrode and the negative electrode. The second electrode includes at least one catalyst material formulated to accelerate oxidative coupling of methane (CH₄) (OCM) reaction rates to produce C₂H₄ from CH₄ and oxygen ions. The method further includes introducing CH₄ to the second electrode of the electrochemical cell. The method also includes applying a potential difference in electrolysis mode between the first electrode and the second electrode of the electrochemical cell. The oxygen-containing molecules interact with the first electrode to produce O²⁻ through reduction of the oxygen-containing molecules, the O²⁻ are transported through the electrolyte, and C₂H₄ is produced at the second electrode through OCM.

Other embodiments of the disclosure include an electrochemical cell. The electrochemical cell comprises a first electrode formulated to facilitate a reduction reaction to produce oxygen ions (O²⁻) from an oxygen-containing molecule. The electrochemical cell also comprises a second electrode formulated to facilitate oxidative coupling of methane (CH₄) (OCM) to produce ethylene (C₂H₄) from CH₄ and the O²⁻, the second electrode comprising at least one catalyst material comprising one or more of La, Pr, and Ce and formulated to accelerate the OCM to produce the C₂H₄ from CH₄ and the O²⁻. The electrochemical cell further comprises an electrolyte between the first electrode and the second electrode.

Other embodiments of the disclosure include a system for producing ethylene (C₂H₄) from oxidative coupling of methane (CH₄) (OCM). The system comprises an electrochemical apparatus in fluid communication with a source of oxygen-containing molecules and a source of CH₄. The electrochemical apparatus also comprises a housing structure configured to receive an oxygen-containing molecule stream from the source of oxygen-containing molecules and to receive a CH₄ stream from the source of CH₄. The electrochemical apparatus also includes one or more electrochemical cells within an internal chamber of the housing structure. The electrochemical cells comprise a first electrode formulated to facilitate a reduction reaction to produce oxygen ions (O²⁻) from an oxygen-containing molecule. The electrochemical cells also comprise a second electrode comprising at least one catalyst material formulated to accelerate an OCM reaction rate to produce C₂H₄ from CH₄ and the oxygen ions (O²⁻). The electrochemical cells further comprise an electrolyte between the first electrode and the second electrode. The electrochemical apparatus further includes a power source configured to apply a potential difference between the first electrode and the second electrode.

### BRIEF DESCRIPTION OF THE DRAWINGS

FIG. 1 is a simplified schematic view of a system for producing ethylene (C₂H₄), in accordance with embodiments of the disclosure;

FIG. 2 is a simplified cross-sectional view of an electrochemical cell for producing C₂H₄, in accordance with embodiments of the disclosure;

FIG. 3 is a simplified flowchart of a method for producing C₂H₄, in accordance with embodiments of the disclosure;

FIG. 4 is a simplified flow chart illustrating a method of forming an La₂O₃ nanorod catalyst, as described in Example 1;

FIGS. 5A and 5B are graphical representations of catalytic performance of an La₂O₃ nanorod catalyst, as described in Example 2;

FIG. 6 is a simplified cross-sectional view of an electrochemical cell, as described in Example 3;

FIG. 7A is a graphical representation of results associated with electron impedance spectroscopy (EIS) measurements, as described in Example 4;

FIG. 7B is a graphical representation showing current density results (e.g., polarization curves) and power density results, as described in Example 4;

FIG. 8A is a graphical representation of electrochemical performance of an electrochemical cell, as described in Example 5;

FIG. 8B is a graphical representation of results associated with EIS measurements, as described in Example 5;

FIG. 8C is a graphical comparison of CH₄ conversion and C2 product selectivity of an electrochemical cell, as described in Example 5;

FIG. 9A is a is a graphical representation of electrochemical performance of an electrochemical cell, as described in Example 7;

FIG. 9B is a graphical representation of results associated with EIS measurements, as described in Example 7;

FIG. 9C is a graphical comparison of CH₄ conversion and C2 product selectivity of an electrochemical cell, as described in Example 7;

FIG. 9D is a graphical comparison of product selectivity of an electrochemical cell, as described in Example 7;

FIG. 10 illustrates X-ray diffraction (XRD) patterns of a Pr_{0.5}Ba_{0.5}FeO_{3-δ} (PBF) catalyst, as described in Example 8;

FIG. 11 is a graphical representation of CH₄ conversion and C2 selectivity of a PBF catalyst, as described in Example 9;

FIG. 12 illustrates an XRD pattern of a La_{0.3}Sr_{0.7}Sc_{0.1}Ti_{0.9}O_{3-δ} (LSScT) catalyst, as described in Example 10;

FIG. 13 is a graphical representation of CH₄ conversion and C2 selectivity of a LSScT catalyst, as described in Example 11;

FIG. 14 is a graphical comparison of CH₄ conversion and C2 selectivity associated with modified LaTiO₃ catalysts, as described in Example 12;

FIG. 15 is an XRD pattern of an LSScT catalyst, as described in Example 13;

FIGS. 16A and 16B show CH₄ conversion and selectivity as functions of temperature, respectively, as described in Example 14;

FIG. 17A is an SEM image showing the microstructure of an Ag-SFMN-SDC|LSGM|SFMN-SDC cell after OCM testing at 750° C., as described in Example 15;

FIG. 17B is an SEM-EDX mapping of an SFMN-SDC|LSGM|SFMN-SDC cell after OCM test with 50% CH₄ for 40 hours at 750° C., as described in Example 15;

FIG. 18A shows the performance of electrochemical CH₄ oxidation on an SFMN-SDC|LSGM|SFMN-SDC cell integrated with LSScT catalyst under different applied voltages at 750° C., as described in Example 16;

FIG. 18B shows the performance of electrochemical CH₄ oxidation on an SFMN-SDC|LSGM|SFMN-SDC cell without the LSScT catalyst under different applied voltages at 750° C., as described in Example 16;

FIG. 19A shows CH₄ conversion on LSScT integrated cell and bare cell under different applied voltages at 750° C., as described in Example 17;

FIG. 19B shows C2 selectivity for LSScT integrated cell and bare cell, as described in Example 17;

FIGS. 20A and 20B show the product distribution on an LSScT cell (FIG. 20A) and on a bare cell (FIG. 20B) under different applied voltages at 750° C., as described in Example 17; and

FIG. 21 is a comparison of the conversion and selectivity across a variety of catalysts.

### DETAILED DESCRIPTION

Methods and systems for producing ethylene (C₂H₄) through oxidative coupling of methane (CH₄) (OCM) are disclosed. In some embodiments, a method of producing C₂H₄ includes introducing an oxygen source stream including oxygen-containing molecules (e.g., CO₂, O₂, H₂O, air) and CH₄ to an electrochemical apparatus including at least one electrochemical cell therein. The electrochemical cell includes a negative electrode (e.g., a cathode), a positive electrode (e.g., an anode), and an electrolyte (e.g., an oxygen ion-conducting membrane) between the negative electrode and the positive electrode. The negative electrode is formulated to facilitate production of oxygen ions (O²⁻) from the oxygen-containing molecules and electrons (e⁻). The positive electrode is formulated to facilitate production of C₂H₄ from CH₄ and the produced O²⁻. The positive electrode includes at least one catalyst material formulated to accelerate (e.g., catalyze) production of the C₂H₄ from the CH₄ and the produced O²⁻. The catalyst material may be highly active and selective, and include one or more of lanthanum (La), praseodymium (Pr), and cerium (Ce). In some embodiments, the catalyst material is a perovskite-structured mixed metal oxide material. The oxygen source stream is introduced to the negative electrode of the electrochemical cell, the CH₄ is introduced to the positive electrode of the electrochemical cell, and a potential difference is applied between the negative electrode and the positive electrode to produce the C₂H₄. The methods, systems, and apparatuses of the disclosure may be more efficient (e.g., increasing C₂H₄ production efficiencies, reducing equipment, material, and/or energy requirements), less complicated, and less carbon intensive as compared to conventional methods (e.g., thermal catalytic processes), conventional systems, and conventional apparatuses for producing C₂H₄. By using the catalyst in the anode of the electrochemical cell, product yield of the C₂H₄ per unit volume of catalyst and per unit time is increased.

The following description provides specific details, such as material compositions and processing conditions (e.g., temperatures, pressures, flow rates, etc.) in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components (e.g., pipelines, line filters, valves, temperature detectors, flow detectors, pressure detectors, and the like) are inherently disclosed herein and that adding various conventional process components and acts would be in accord with the disclosure. In addition, the drawings accompanying the application are for illustrative purposes only and are not meant to be actual views of any particular material, device, or system.

As used herein, the terms “catalyst material” and “catalyst” each mean and include a material formulated to promote one or more reactions, resulting in the formation of a product.

As used herein, the term “negative electrode” means and includes an electrode having a relatively lower electrode potential in an electrochemical cell (i.e., lower than the electrode potential in a positive electrode therein). Conversely, as used herein, the term “positive electrode” means and includes an electrode having a relatively higher electrode potential in an electrochemical cell (i.e., higher than the electrode potential in a negative electrode therein). Which of the electrodes in the electrochemical cell is positive or negative may depend on an electrical potential being applied to the electrochemical cell. For instance, if the potential is reversed, the polarity of the electrodes will be reversed as well. The negative electrode and the positive electrode may alternatively be termed the “cathode” and the “anode,” respectively.

As used herein the term “electrolyte” means and includes an ionic conductor, which can be in a solid state, a liquid state, or a gas state (e.g., plasma).

As used herein, the term “compatible” means that a material does not undesirably react, decompose, or absorb another material, and also that the material does not undesirably impair the chemical and/or mechanical properties of the other material.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “configured” refers to a size, shape, material composition, material distribution, and arrangement of one or more of at least one structure and at least one apparatus facilitating operation of one or more of the structure and the apparatus in a pre-determined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, at least 99.9% met, or even 100.0% met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

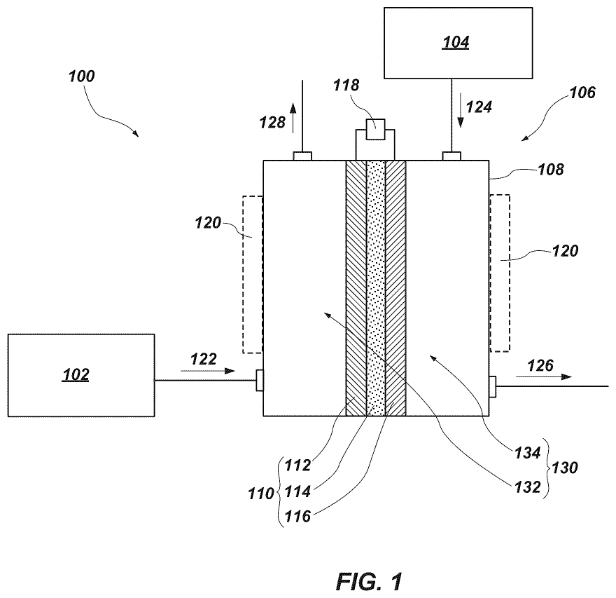

FIG. 1 illustrates a simplified schematic view of a system 100 for producing ethylene (C₂H₄) from methane (CH₄) according to embodiments of the disclosure. The system 100 may be used to convert CH₄ and one or more oxygen-containing materials (e.g., oxygen-containing molecules, oxygen-containing compounds, such as CO₂, H₂O, O₂, air, or a combination thereof) into C₂H₄. As shown in FIG. 1, the system 100 may include at least one oxygen source 102 (e.g., a containment vessel), at least one CH₄ source 104 (e.g., a containment vessel), and at least one electrochemical apparatus 106 in fluid communication with each of the oxygen source 102 and the CH₄ source 104. The electrochemical apparatus 106 includes a housing structure 108, and at least one electrochemical cell 110 contained within the housing structure 108. The electrochemical cell 110 is electrically connected (e.g., coupled) to a power source 118, and includes a cathode 112 (e.g., a negative electrode), an anode 116 (e.g., a positive electrode), and an electrolyte 114 (e.g., an oxygen ion-conducting electrolyte, an oxygen ion-conducting membrane) between the cathode 112 and the anode 116. The power source 118 may provide clean (e.g., carbon-free) electricity (e.g., electricity that is generated without direct emissions of greenhouse gases, such as CO₂, during the generating process).

The system 100 may be configured as an electrochemical membrane reactor (EMR). In some embodiments, the electrochemical cell 110 is an oxygen ion-conducting solid oxide electrochemical cell (OC-SOEC). The electrochemical cell 110 may operate as an electrolysis cell to convert CH₄ into C₂H₄. The electrochemical cell 110 may, alternatively, operate in reverse as a fuel cell to generate electricity from C₂H₄ (e.g., at least a portion of the C₂H₄ produced when the electrochemical cell is operated as an electrolysis cell). The electrochemical cell 110 may operate at an operational temperature within a range of from about 600° C. to about 900° C., such as from about 650° C. to about 900° C., from about 700° C. to about 900° C., from about 750° C. to about 900° C., from about 800° C. to about 900° C., from about 850° C. to about 900° C., from about 600° C. to about 850° C., from about 600° C. to about 800° C., from about 600° C. to about 750° C., from about 600° C. to about 700° C., or from about 600° C. to about 650° C. As shown in FIG. 1, optionally, the system 100 may also include at least one heating apparatus 120 operatively associated with the electrochemical apparatus. The heating apparatus 120 may generate heat via a clean (e.g., carbon-free) process (e.g., a process that generates heat without direct emissions of greenhouse gases, such as CO₂, during the process).

During use and operation, the system 100 directs an oxygen source stream 122 from the oxygen source 102 into the electrochemical apparatus 106 to interact with the cathode 112 of the electrochemical cell 110. The oxygen source stream 122 functions as a source of oxygen and provides one or more oxygen-containing materials (e.g., oxygen-containing molecules) to the electrochemical apparatus 106. For example, the oxygen source stream 122 may be formed of and include one or more of carbon dioxide (CO₂), oxygen (O₂), air, and water (H₂O). In some embodiments, the oxygen source stream 122 is formed of and includes CO₂. In some embodiments, the oxygen source stream 122 is at least substantially free of materials other than CO₂. The oxygen source stream 122 may be at least substantially gaseous.

A potential difference (e.g., a voltage) is applied between the cathode 112 and the anode 116 of the electrochemical cell 110 by the power source 118 so that as the oxygen-containing molecules (e.g., CO₂, O₂, H₂O, air) interact with the cathode 112, the oxygen-containing molecules (e.g., CO₂, O₂, H₂O, air) decompose via a reduction reaction in the presence of electrons (e⁻) to generate oxygen ions (O²⁻) and one or more reduction products (e.g., CO, H₂). For example, if the oxygen source stream 122 includes CO₂, the CO₂ may decompose at the cathode 112 to generate CO and O²⁻ in a CO₂ reduction reaction (CO₂RR), according to the following equation:

2CO₂+4e⁻→2CO+2O²⁻ (1).

The generated O²⁻ permeates (e.g., diffuses) across the electrolyte 114 to the anode 116. A flux of O²⁻ across the electrolyte 114 may be controlled by the potential difference applied between the cathode 112 and the anode 116. At the anode 116, the generated O²⁻ exiting the electrolyte 114 reacts with CH₄ introduced (e.g., delivered) into the electrochemical apparatus from a CH₄ stream 124 from the CH₄ source 104 in the presence of a catalyst material of the anode 116 to produce C₂H₄ via oxidative coupling of methane (OCM), according to the following equation:

2CH₄+2O²⁻→C₂H₄+2H₂O+4e⁻ (2).

The reaction may also form other C2+(e.g., containing two or more carbon atoms) products, such as ethane, propane, or propylene.

The generated e⁻ are directed to the power source 118 through external circuitry (not shown). The e⁻ generated at the anode 116 may, for example, flow from the anode 116 through the power source 118 and into the cathode 112 when the system 100 is operated as an electrochemical cell 110.

The produced C₂H₄ exits the electrochemical apparatus as C₂H₄ product stream 126. In some embodiments, the H₂O produced at the anode 116 is separated from the C₂H₄ product stream 126. At the cathode 112, products of the reduction reaction (e.g., CO, H₂) may exit the electrochemical apparatus as reduction product stream 128.

As described in further detail below, the production of O²⁻ at the cathode 112 and C₂H₄, H₂O, and e⁻ at the anode 116 may at least partially depend on the material compositions and flow rates of the oxygen source stream 122 and the CH₄ stream 124; the configuration (e.g., size, shape, material composition, material distribution, arrangement) of the cathode 112; the configuration of the electrolyte 114, and the impact thereof on the diffusivity (e.g., diffusion rate) of generated O²⁻ therethrough; the configuration of the anode 116, including the types, quantities, and properties (e.g., geometric properties, thermodynamic properties, etc.) of catalyst materials thereof; and the operational parameters (e.g., temperatures, pressures, etc.) of the electrochemical apparatus 106. Such operational factors may be controlled (e.g., adjusted, maintained, etc.) as desired to control the quantities and rate of production of the O²⁻ produced at the cathode 112 and to control the quantity and rate of production of the C₂H₄, H₂O, and e⁻ produced at the anode 116.

The oxygen source 102 may include at least one apparatus configured and operated to produce the oxygen source stream 122 including one or more oxygen-containing materials. The oxygen source 102 may receive a H₂O recycle stream (not shown) containing one or more phases of H₂O exiting the electrochemical apparatus 106. The oxygen-containing materials (e.g., CO₂, O₂, air, H₂O) may be present in the oxygen source stream 122 in one or more of a gaseous phase and a liquid phase. The phase(s) of the oxygen-containing materials (and, hence, a temperature and pressure of the oxygen source stream 122) of the oxygen source stream 122 may at least partially depend on the operating temperature of the electrochemical cell 110 of the electrochemical apparatus 106. In some embodiments, the oxygen source 102 is configured and operated to heat the oxygen-containing materials of the oxygen source stream 122 to a temperature within a range of an operating temperature of the electrochemical cell 110 of the electrochemical apparatus 106, such as a temperature within a range of from about 600° C. to about 900° C., from about 650° C. to about 900° C., from about 700° C. to about 900° C., from about 750° C. to about 900° C., from about 800° C. to about 900° C., from about 850° C. to about 900° C., from about 600° C. to about 850° C., from about 600° C. to about 800° C., from about 600° C. to about 750° C., from about 600° C. to about 700° C., or from about 600° C. to about 650° C. In some embodiments, the oxygen source 102 is configured and operated to provide the oxygen source stream 122 at a temperature below the operating temperature of the electrochemical cell 110. In such embodiments, the heating apparatus 120 may be employed to further heat the oxygen source stream 122 to the operational temperature of the electrochemical cell 110, as described in further detail below. One or more apparatuses (e.g., heat exchangers, pumps, compressors, expanders, mass flow control devices, etc.) may be employed within the system 100 to adjust the one or more of the temperature, pressure, and flow rate of the oxygen source stream 122 delivered into the electrochemical apparatus 106.

A single (e.g., only one) oxygen source stream 122 may be directed into the electrochemical apparatus 106 from the oxygen source 102, or multiple (e.g., more than one) oxygen source streams 122 may be directed into the electrochemical apparatus 106 from the oxygen source 102. If multiple oxygen source streams 122 are directed into the electrochemical apparatus 106, each of the multiple oxygen source streams 122 may exhibit at least substantially the same properties (e.g., at least substantially the same material composition, at least substantially the same temperature, at least substantially the same pressure, at least substantially the same flow rate, etc.), or at least one of the multiple oxygen source streams 122 may exhibit one or more different properties (e.g., a different material composition, a different temperature, a different pressure, a different flow rate, etc.) than at least one of the other multiple oxygen source streams 122.

The CH₄ stream 124 entering the electrochemical apparatus 106 may be formed of and include CH₄. The CH₄ may be present in the CH₄ stream 124 in one or more of a gaseous phase and a liquid phase. The phase(s) of the CH₄ (and, hence, a temperature and a pressure of the CH₄ stream 124) may at least partially depend on the operating temperature of the electrochemical cell 110 of the electrochemical apparatus 106. The CH₄ stream 124 may only include CH₄ (e.g., about 100% CH₄), or may include CH₄ and one or more other materials, such as, for example, one or more other hydrocarbons (e.g., ethane (C₂H₆), butane (C₄H₁₀), propane (C₃H₈), pentane (C₅H₁₂), hexane (C₆H₁₄), etc.). In some embodiments, the CH₄ stream 124 is formed of and includes natural gas including CH₄ and one or more other materials. One or more apparatuses (e.g., heat exchangers, pumps, compressors, expanders, mass flow control devices, etc.) may be employed within the system 100 to adjust one or more of the temperature, pressure, and flow rate of the CH₄ stream 124 delivered into the electrochemical apparatus 106.

A single (e.g., only one) CH₄ stream 124 may be directed into the electrochemical apparatus 106, or multiple (e.g., more than one) CH₄ streams 124 may be directed into the electrochemical apparatus 106. If multiple CH₄ streams 124 are directed into the electrochemical apparatus 106, each of the multiple CH₄ streams 124 may exhibit at least substantially the same properties (e.g., at least substantially the same material composition, at least substantially the same temperature, at least substantially the same pressure, at least substantially the same flow rate, etc.), or at least one of the multiple CH₄ streams 124 may exhibit one or more different properties (e.g., a different material composition, a different temperature, a different pressure, a different flow rate, etc.) than at least one other of the multiple CH₄ streams 124. In some embodiments, at least one of the multiple CH₄ streams 124 is a recycle CH₄ stream (not shown) containing one or more phases of unreacted CH₄ separated from C₂H₄ product stream 126 exiting the electrochemical apparatus 106.

The heating apparatus 120, if present, may comprise at least one apparatus (e.g., one or more of a combustion heater, an electrical resistance heater, an inductive heater, and an electromagnetic heater) configured and operated to heat one or more of the oxygen source stream 122, the CH₄ stream 124, and at least a portion of the electrochemical apparatus 106 to an operating temperature of the electrochemical apparatus 106. The operating temperature of the electrochemical apparatus 106 may at least partially depend on a material composition of the electrolyte 114 of the electrochemical cell 110, as described in further detail below. In some embodiments, the heating apparatus 120 heats one or more of the oxygen source stream 122, the CH₄ stream 124, and at least a portion of the electrochemical apparatus 106 to a temperature within a range of from about 600° C. to about 900° C., such as from about 650° C. to about 900° C., from about 700° C. to about 900° C., from about 750° C. to about 900° C., from about 800° C. to about 900° C., from about 850° C. to about 900° C., from about 600° C. to about 850° C., from about 600° C. to about 800° C., from about 600° C. to about 750° C., from about 600° C. to about 700° C., or from about 600° C. to about 650° C. In additional embodiments, such as in embodiments where a temperature of one or more of the oxygen source stream 122 and the CH₄ stream 124 is already within the operating temperature range of the electrochemical cell 110 of the electrochemical apparatus 106, the heating apparatus 120 may be omitted (e.g., absent) from the system 100.

With continued reference to FIG. 1, the electrochemical apparatus 106, including the housing structure 108 and the electrochemical cell 110 thereof, is configured and operated to form the C₂H₄ product stream 126 and the reduction product stream 128 from the oxygen source stream 122 and the CH₄ stream 124 when the system 100 is operated as the electrochemical cell 110. The C₂H₄ product stream 126 and the reduction product stream 128 may be formed according to at least one reduction reaction to generate O²⁻ from the oxygen-containing materials (e.g., oxygen-containing molecules) of the oxygen source stream 122, such as the reaction of Equation (1) above, and the OCM reaction of Equation (2) above. The housing structure 108 may exhibit any shape (e.g., a tubular shape, a quadrilateral shape, a spherical shape, a semi-spherical shape, a cylindrical shape, a semi-cylindrical shape, truncated versions thereof, or an irregular shape) and size able to contain (e.g., hold) the electrochemical cell 110 therein, to receive and direct the oxygen source stream 122 to the cathode 112 of the electrochemical cell 110, to direct the one or more reduction products (e.g., CO, H₂) formed at the cathode 112 away from the electrochemical apparatus 106 as the reduction product stream 128, and to direct the C₂H₄ formed at the anode 116 of the electrochemical cell 110 away from the electrochemical apparatus 106 as the C₂H₄ product stream 126. In addition, the housing structure 108 may be formed of and include any material (e.g., glass, metal, alloy, polymer, ceramic, composite, combination thereof, etc.) compatible with the operating conditions (e.g., temperatures, pressures, etc.) of the electrochemical apparatus 106.

The housing structure 108 may at least partially define at least one internal chamber 130 at least partially surrounding the electrochemical cell 110. The electrochemical cell 110 may serve as a boundary between a first region 132 (e.g., a cathodic region) of the internal chamber 130 configured and positioned to receive the oxygen source stream 122 and to direct the reduction product stream 128 from the electrochemical apparatus 106, and a second region 134 (e.g., an anodic region) of the internal chamber 130 configured and positioned to receive the one or more hydrocarbon compounds produced at the anode 116 of the electrochemical cell 110. Molecules of the oxygen source stream 122 may be substantially limited to the first region 132 of the internal chamber 130 by the configurations and positions of the housing structure 108 and the electrochemical cell 110. Keeping the second region 134 of the internal chamber 130 substantially free of molecules from the oxygen source stream 122 circumvents additional processing of the produced C₂H₄ (e.g., to separate the produced C₂H₄ from CO₂, O₂, and/or one or more components of air (e.g., N₂, Ar, etc.)) that may otherwise be necessary if the components of the oxygen source stream 122 were also delivered to within the second region 134 of the internal chamber 130.

As shown in FIG. 1, the cathode 112 and the anode 116 of the electrochemical cell 110 are electrically coupled to the power source 118, and the electrolyte 114 is disposed on and between the cathode 112 and the anode 116. The electrolyte 114 is configured and formulated to conduct O²⁻ from the cathode 112 to the anode 116, while electrically insulating the anode 116 from the cathode 112. The O²⁻ generated at the cathode 112 flow from the cathode 112 through the electrolyte 114 to the anode 116 to form C₂H₄ at the anode 116 through the OCM reaction of Equation (2) described above. Electrons generated at the anode 116 through the reaction of Equation (2) described above may, for example, flow from the anode 116 into a positive electrode current collector (e.g., anode current collector), through the power source 118 and a negative electrode current collector (e.g., cathode current collector), and into the cathode 112 to facilitate the reduction reaction and decomposition of the oxygen-containing materials of the oxygen source stream 122 at the cathode 112 to form O²⁻. For example, if the oxygen source stream 122 includes CO₂, the electrons generated at the anode 116 may flow from the anode 116 into the positive electrode current collector, through the power source 118 and the negative electrode current collector, and into the cathode 112 to facilitate the reduction of CO₂ at the cathode 112 to form O²⁻ through the reaction of Equation (1) described above.

The electrolyte 114 may be an oxygen ion-conducting membrane. The electrolyte 114 may be formed of and include at least one electrolyte material exhibiting an ionic conductivity (e.g., O²⁻ conductivity) greater than or equal to about 0.1 S/cm, such as within a range of from about 0.1 S/cm to about 0.15 S/cm, at one or more temperatures within a range of from about 600° C. to about 900° C. By way of non-limiting example, the electrolyte 114 may be formed of and include yttria-stabilized zirconia (YSZ) materials, scandia-stabilized zirconia (ScSZ) materials, lanthanum gallate (LaGaO₃) materials (e.g., doped LaGaO₃ materials, La_{0.9}Sr_{0.1}Ga_{0.8}Mg_{0.2}O_{3-δ} (LSGM), where δ is an oxygen deficit, ytterbium-stabilized zirconia (YbSZ) materials, ceria (CeO₂) materials (e.g., doped CeO₂ materials, such as gadolinia-doped CeO₂ (GDC)), samaria-doped CeO₂ (SDC)), bismuth oxide (Bi₂O₃) materials, yttria-stabilized bismuth oxide (YSB) materials, and thorium dioxide (ThO₂) materials. In some embodiments, the electrolyte 114 is formed of and includes LSGM.

The electrolyte 114 may be at least substantially homogeneous (e.g., exhibiting an at least substantially uniform material composition throughout the electrolyte 114) or may be at least substantially heterogeneous (e.g., exhibiting varying material composition throughout the electrolyte 114). In some embodiments, the electrolyte 114 is at least substantially homogeneous. In additional embodiments, the electrolyte 114 is at least substantially heterogeneous. The electrolyte 114 may, for example, include a stack of at least two (e.g., at least three, at least four, etc.) different electrolyte materials.

The electrolyte 114 may exhibit any desired dimensions (e.g., length, width, thickness) and any desired shape, such as one of a cubic shape, a cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, or an irregular shape. The dimensions and shape of the electrolyte 114 may be selected such that the electrolyte 114 at least substantially intervenes between opposing surfaces of the cathode 112 and the anode 116. A thickness of the electrolyte 114 may at least partially depend on the material composition and thickness of one or more of the cathode 112 and the anode 116. In some embodiments, a thickness of the electrolyte 114 is at least about 10 microns (μm), such as, for example, at least about 150 μm, at least about 200 μm, or at least about 250 μm.

The cathode 112 may be formed of and include a material compatible with the material of the electrolyte 114 and a material of the anode 116 under the operating conditions (e.g., temperature, pressure, current density, etc.) of the electrochemical cell 110. The material composition of the cathode 112 may facilitate the production of O²⁻ and one or more reduction products (e.g., CO, H₂) from the oxygen-containing materials of the oxygen source stream 122. The material of the cathode 112 may be a porous material. The cathode 112 may be formed of and include any suitable cathode material for use in a SOEC. By way of non-limiting example, when CO₂ or water is used as the oxygen source, the cathode 112 may be formed of and include at least one cermet material. For example, one or more of a cermet material including at least one metal (e.g., Ni) and at least one ceramic material (e.g., one or more of a yttrium- and ytterbium-stabilized zirconate (YSZ), scandia-stabilized zirconia (ScSZ) materials, lanthanum gallate (LaGaO₃) materials), such as a nickel cermet (Ni-electrolyte, e.g., Ni—YSZ, Ni—ScSZ, Ni-LSGM). When O₂ or air is used as the oxygen source, the cathode 112 may be formed of and include at least one perovskite material such as lanthanum strontium manganate (LSM), lanthanum strontium cobalt ferrite (LSCF), or strontium iron molybdenite (SFM). In this case, the cathode 112 may also be formed of and include a composite ceramic material, such as a ceramic material including, for example, gadolinia-doped CeO₂ (GDC), samaria-doped ceria (SDC) (e.g., Ce_{0.8}Sm_{0.2}O_{1.95}) and one or more of Sr₂FeMo_{0.8}Ni_{0.2}O_{6-δ} (SMFN), where δ is an oxygen deficit, and Sr₂Fe_{1.5}Mo_{0.5}O_{6-δ} (SFM), where δ is an oxygen deficit (SFM). In some embodiments, the cathode 112 is formed of and includes SFMN-SDC.

Optionally, the cathode 112 may include at least one catalyst material thereon, thereover, and/or therein. For example, at least one catalyst material may be included on, over, and/or within the material of the cathode 112 to accelerate (e.g., catalyze) reaction rates (e.g., reduction reaction rates) at the cathode 112 to produce O²⁻ and one or more reduction products (e.g., CO, H₂) from the oxygen-containing materials of the oxygen source stream 122.

The anode 116 may be formed of and include a material compatible with the material of the electrolyte 114 and the material of the cathode 112 under the operating conditions (e.g., temperature, pressure, current density, etc.) of the electrochemical cell 110. The material composition of the anode 116 may facilitate the production of C₂H₄, H₂O, and e⁻ from CH₄ and O²⁻. The material of the anode 116 may be a porous material. The anode 116 may be formed of and include any suitable anode material for use in a SOEC. By way of non-limiting example, the anode 116 may be formed of and include one or more of a mixed ionic-electronic conducting perovskite material, such as Pr(Co_{1-x-y-z}, Niₓ, Mn_{y}, Fe_{z})O_{3-δ}, wherein 0≤x≤0.9, 0≤y≤0.9, 0≤z≤0.9, (x+y+z≤1) and δ is an oxygen deficit (e.g., PrNi_{0.5}Co_{0.5}O_{3-δ} (PNC55)) or (Pr₁₋ₓLnₓ)(Ba₇,Sr_{1-y})(Co_{z},Tn_{1-z})O_{50δ}, wherein Ln is selected from La, Nd, Ce, Pm, Sm, Er, Gd, Dy, Ho, and Yb; Tn is selected from Fe, Ni, Cu, Zn, Mn, Cr, and Nd, 0≤x≤1, 0≤y≤1, 0≤z≤1, and δ is the oxygen deficit (e.g., Pr_{0.5}La_{0.5}BaCo₂O_{3-δ} (PLBC)); a double perovskite material, such as MBa₁₋ₓSrₓCo_{2-y}Fe_{y}O_{5-δ}, wherein x and y are dopant levels, δ is the oxygen deficit, and M is Pr, Nd, or Sm (e.g., PrBa_{0.5}Sr_{0.5}Co_{1.5}Fe_{0.5}O_{5-δ} (PBSCF), NdBa_{0.5}Sr_{0.5}Co_{1.5}Fe_{0.5}O_{5-δ}, SmBa_{0.5}Sr_{0.5}Co_{1.5}Fe_{0.5}O_{5-δ}) or MBa₁₋ₓCaₓCo₂O_{5-δ}, wherein x is a dopant level, δ is the oxygen deficit and M is Pr, Nd, or Sm (e.g., PrBa_{0.8}Ca_{0.2}Co₂O_{5-δ} (PBCC)); a single perovskite material, such as Sm₁₋ₓSrₓCoO_{3-δ} (SSC), BaZr_{1-x-y-z}CoₓFe_{y}Y_{z}O_{3-δ}, or SrScₓNd_{y}Co_{1-x-y}O_{3-δ}, wherein x, y, and z are dopant levels and δ is the oxygen deficit; a Ruddleson-Popper-type perovskite material, such as M₂NiO_{4-δ}, wherein δ is the oxygen deficit and M is La, Pr, Gd, or Sm (e.g., La₂NiO_{4-δ}, Pr₂NiO_{4-δ}, Gd₂NiO_{4-δ}, Sm₂NiO_{4-δ}); a single perovskite/perovskite composite material such as SSC-SFM; strontium-based lanthanum manganite (LSM) material, such as La_{0.4}Sr_{0.6}Ti_{0.8}Mn_{0.2}O_{3-δ} (LSTM); and a ceramic composite material, such as SFMN-SDC, SFM-SDC, and LSTM-SDC. In some embodiments, the anode 116 is formed of and includes SFMN-SDC.

The anode 116 may include at least one catalyst material that accelerates (e.g., catalyzes) reaction rates (e.g., OCM reaction rates) at the anode 116 to produce C₂H₄, H₂O, and e⁻ from CH₄ and O²⁻. The catalyst material of the anode 116 may be electrically conductive. The at least one catalyst material of the anode 116 may exhibit a C₂H₄ product selectivity greater than about 15%, such as, for example, greater than about 30%, greater than about 40%, greater than about 50%, greater than about 80%, greater than about 70%, greater than about 80%, or greater than about 90%. In some embodiments the at least one catalyst material of the anode 116 exhibits a C₂H₄ product selectivity greater than about 40%. The anode 116 may be formed of and include the at least one catalyst material. In some embodiments, the anode 116 includes the at least one catalyst material on, over, and/or within the material of the anode 116. In some embodiments, the anode 116 includes the at least one catalyst material over a positive electrode current collector, the positive electrode current collector disposed between the anode 116 and the at least one catalyst material. In some embodiments, the at least one catalyst material is disposed on a side of the anode 116 opposite the electrolyte 114. In some embodiments, the at least one catalyst material of the anode 116 includes a nanostructured material (e.g., at least one dimension of structural elements (e.g., clusters, crystals, molecules) of the material is less than about one (1) μm, such as less than or equal to about 100 nm, less than or equal to about 20 nm, or less than or equal to about 10 nm). The anode 116 may include any amount (e.g., concentration) and distribution of the at least one catalyst material and any ratio of components thereof facilitating desired OCM reactions at the anode 116.

The at least one catalyst material of the anode 116 may include one or more of lanthanum (La), praseodymium (Pr), and cerium (Ce). The at least one catalyst material of the anode 116 may include an oxide of one or more of La, Pr, and Ce, such as, for example, one or more of La₂O₃, PrO₂, and CeO₂. In some embodiments, the at least one catalyst material of the anode 116 is formed of and includes La₂O₃. In some embodiments, the at least one catalyst material of the anode 116 is a lanthanum oxide (La₂O₃)-based catalyst. The at least one catalyst material of the anode 116 may include one or more metal elements, such as, for example, one or more of lithium (Li), strontium (Sr), and iron (Fe). By way of non-limiting example, the at least one catalyst material of the anode 116 may include one or more of Li—La₂O₃, Sr—La₂O₃, Fe—La₂O₃, Li—PrO₂, Sr—PrO₂, Fe—PrO₂, Li—CeO₂, Sr—CeO₂, and Fe—CeO₂. The at least one catalyst material of the anode 116 may include nanorods of the at least one catalyst material. The nanorods may have a diameter of less than about 100 nm, such as within a range of from about 10 nm to about 100 nm, from about 20 nm to about 100 nm, or from about 50 nm to about 100 nm.

In some embodiments, the at least one catalyst material of the anode 116 is a perovskite-structured mixed metal oxide material exhibiting a cubic lattice structure with a general formula ABO_{3-δ}, where A may include one or more of lanthanum (La), praseodymium (Pr), cerium (Ce), barium (Ba), strontium (Sr), and calcium (Ca), B may include one or more of aluminum (Al) and one or more transition metals, such as, for example, titanium (Ti), manganese (Mn), iron (Fe), scandium (Sc), etc., and δ is the oxygen deficit. By way of non-limiting example, the at least one catalyst material of the anode 116 may be formed of and include one or more of a lanthanum-titanate (LaTiO₃) (e.g., a doped LaTiO₃), a lanthanum-strontium-titanate (LST), such as (La_{0.3}Sr_{0.7})_{0.9}TiO_{3-δ}, a scandium-doped LaSrTi (LSScT), such as (La_{0.8}Sr_{0.2})_{0.99}Sc_{0.9}Ti_{0.1}O_{3-δ} and La_{0.3}Sr_{0.7}Sc_{0.1}Ti_{0.9}O_{3-δ}, a cerium-doped LaSrTi (LSCT), such as La_{0.23}Sr_{0.67}Ce_{0.1}TiO_{3-δ}, a manganese-doped LaSrTi (LSMT), such as La_{0.6}Sr_{0.4}Mn_{0.8}Ti_{0.2}O_{3-δ}, an aluminum-doped LaSrTi (LSAT), such as La_{0.33}Sr_{0.67}Al_{0.08}Ti_{0.92}O_{3-δ}, a barium-doped LaSrTi (LSBT), such as La_{0.4}Sr_{0.5}Ba_{0.1}TiO_{3-δ}, a calcium-doped LaSrTi (LSCT), such as La_{0.2}Sr_{0.25}Ca_{0.45}TiO_{3-δ}, a lanthanum-barium-ferrate (LBF), such as La_{0.5}Ba_{0.5}FeO_{3-δ}, or a chlorine doped a lanthanum-barium-ferrate, such as La_{0.5}Ba_{0.5}FeCl₂O_{1-δ} (LBFCl), a cobalt doped LaSrTi (LSCoT) such as La_{0.3}Sr_{0.7}Co_{0.07}Ti_{0.93}O_{3-δ}, and a praseodymium-barium-ferrate (PBF), such as Pr_{0.5}Ba_{0.5}FeO_{3-δ}. In some embodiments, the at least one catalyst material of the anode 116 is formed of and includes La_{0.8}Sr_{0.2}Sc_{0.9}Ti_{0.1}O_{3-δ}. In some embodiments, the perovskite-structured mixed metal oxide material is subjected to at least one reduction treatment.

The cathode 112 and the anode 116 may each individually exhibit any desired dimensions (e.g., length, width, thickness) and any desired shape (e.g., a cubic shape, cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, and irregular shape). The dimensions and the shapes of the cathode 112 and the anode 116 may be selected relative to the dimensions and the shape of the electrolyte 114 such that the electrolyte 114 substantially intervenes between opposing surfaces of the cathode 112 and the anode 116. Thicknesses of the cathode 112 and the anode 116 may each individually be within a range of from about 10 μm to about 1000 μm.

By selecting catalysts in the anode 116 to exhibit a relatively high (e.g., greater than about 15% C₂H₄ selectivity, the system 100 may be used to more efficiently produce C₂H₄ compared to conventional thermal catalytic processes in fixed bed flow reactors. Supplying oxygen to the electrochemical apparatus 106 via the oxygen source stream 122 allows for even distribution of oxygen-containing materials throughout the volume of the cathodic region 132, maintaining a low and at least substantially homogeneous partial pressure of oxygen in the electrochemical apparatus 106. The low and at least substantially homogeneous partial pressure of oxygen in the electrochemical apparatus 106 enables partial oxidation of CH₄, thus increasing the selectivity to higher hydrocarbon products (e.g., C₂H₄). Since heat and electricity used in the system 100 may be obtained from carbon-free processes, such as from renewable, solar, nuclear, or carbon capture processes, C₂H₄ may be formed with significant reductions in process energy and carbon intensity compared to conventional processes. The produced C₂H₄ may be used as a precursor for manufacturing polymers, chemical intermediates, and solvents at reduced costs, greater efficiency, and reduced carbon intensity.

The electrochemical cell 110, including the cathode 112, the electrolyte 114, and the anode 116 thereof, may be formed through conventional processes (e.g., rolling process, milling processes, shaping processes, pressing processes, consolidation processes, etc.), which are not described in detail herein. The electrochemical cell 110 may be mono-faced or bi-faced and may have a prismatic, folded, wound, cylindrical, or jelly rolled configuration. The electrochemical cell 110 may be placed within the housing structure 108 to form the electrochemical apparatus 106 and may be electrically connected to the power source 118.

Although the electrochemical apparatus 106 is depicted as including a single (i.e., only one) electrochemical cell 110 in FIG. 1, the electrochemical apparatus 106 may include any number of electrochemical cells 110. Put another way, the electrochemical apparatus 106 may include a single (e.g., only one) electrochemical cell 110, or may include multiple (e.g., more than one) electrochemical cells 110. If the electrochemical apparatus 106 includes multiple electrochemical cells 110, each of the electrochemical cells 110 may be substantially the same (e.g., exhibit substantially the same components, component sizes, component shapes, component material compositions, component material distributions, component positions, component orientations, etc.) and may be operated under substantially the same conditions (e.g., substantially the same temperatures, pressures, flow rates, etc.), or at least one of the electrochemical cells 110 may be different (e.g., exhibit one or more of different components, different component sizes, different component shapes, different component material compositions, different component material distributions, different component positions, different component orientations, etc.) than at least one other of the electrochemical cells 110 and/or may be operated under different conditions (e.g., different temperatures, different pressures, different flow rates, etc.) than at least one other of the electrochemical cells 110. By way of non-limiting example, one of the electrochemical cells 110 may be configured for and operated under a different temperature (e.g., different operating temperature resulting from a different material composition of one of more components thereof, such as a different material composition of the electrolyte 114 thereof) than at least one other of the electrochemical cells 110. In some embodiments, two or more electrochemical cells 110 are used in parallel with one another within the housing structure 108 of the electrochemical apparatus 106 and may individually produce a portion of the C₂H₄ directed out of the electrochemical apparatus 106 as the C₂H₄ product stream 126.

Still referring to FIG. 1, the reduction product stream 128 and the C₂H₄ product stream 126 exiting the electrochemical apparatus 106 may individually be utilized or disposed of as desired. In some embodiments, the reduction product stream 128 and the C₂H₄ product stream 126 are individually delivered into one or more storage vessels (not shown) for subsequent use, as desired. In additional embodiments, at least a portion of one or more of the reduction product stream 128 and the C₂H₄ product stream 126 may be utilized (e.g., combusted) to heat one or more components (e.g., the heating apparatus 120 (if present); the electrochemical apparatus 106; etc.) and/or streams (e.g., the oxygen source stream 122, the CH₄ stream 124) of the system 100. By way of non-limiting example, if the heating apparatus 120 (if present) is a combustion-based apparatus, at least a portion of one or more of the reduction product stream 128 and the C₂H₄ product stream 126 may be directed into the heating apparatus 120 and undergo a combustion reaction to efficiently heat one or more of the oxygen source stream 122 entering the electrochemical apparatus 106, the CH₄ stream 124 entering the electrochemical apparatus 106, and at least a portion of the electrochemical apparatus 106. Utilizing the reduction product stream 128 and/or the C₂H₄ product stream 126 as described above may reduce the electrical power requirements of the system 100 by enabling the utilization of direct thermal energy. Unreacted CH₄ and H₂O produced at the anode 116 may be separated from the C₂H₄ product stream 126 and individually delivered into one or more storage vessels (not shown) for subsequent use, as desired. In some embodiments, the unreacted CH₄ separated from the C₂H₄ product stream 126 is delivered into the electrochemical apparatus 106 as a CH₄ recycle stream (not shown) to interact with the anode 116. The C₂H₄ product stream may be recovered and used as a precursor material for manufacturing polymers, chemical intermediates, and solvents in the chemical industry. In addition to the C₂H₄ product stream, the reduction product stream 128, including reduction products such as one or more of CO and H₂, may be a useful co-product of the system and methods according to embodiments of the disclosure.

Thermal energy input into (e.g., through the heating apparatus 120 (if present)) and/or generated by the electrochemical apparatus 106 may also be used to heat one or more other components and/or streams of the system 100. By way of non-limiting example, the reduction product stream 128 and/or the C₂H₄ product stream 126 exiting the electrochemical apparatus 106 may be directed into a heat exchanger configured and operated to facilitate heat exchange between the reduction product stream 128 and/or the C₂H₄ product stream 126 of the system 100 and one or more other relatively cooler streams (e.g., the oxygen source stream 122, the CH₄ stream 124) of the system 100 to transfer heat from the reduction product stream 128 and/or the C₂H₄ product stream 126 to the relatively cooler stream(s) to facilitate the recovery of the thermal energy input into and generated within the electrochemical apparatus 106. The recovered thermal energy may increase process efficiency and/or reduce operational costs without having to react (e.g., combust) reduction products (e.g., CO) of the reduction product stream 128 and/or C₂H₄ of the C₂H₄ product stream 126.

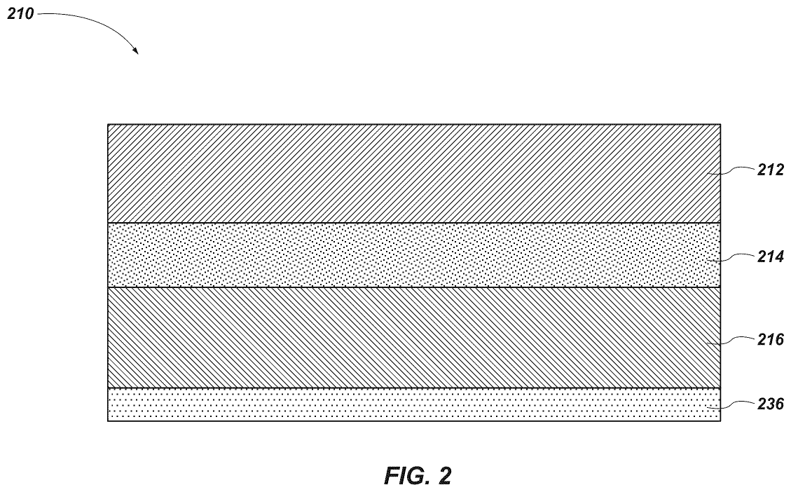

FIG. 2 illustrates a simplified cross-sectional view of an electrochemical cell 210 for producing C₂H₄, according to embodiments of the disclosure. The electrochemical cell 210 may be at least substantially similar to the electrochemical cell 110 previously described with reference to FIG. 1. The electrochemical cell 210 may include a cathode 212, an anode 216, and an electrolyte 214 disposed between the cathode 212 and the anode 216. The electrochemical cell 210 may include an anode catalyst material 236 disposed on a side of the anode 216 opposite the electrolyte 214. The anode catalyst material 236 may be at least substantially similar to the at least one catalyst material of the anode 116 previously described with reference to FIG. 1. In some embodiments, the electrochemical cell 210 includes a current collector (e.g., an anode current collector) (not shown) disposed between the anode 216 and the anode catalyst material 236.

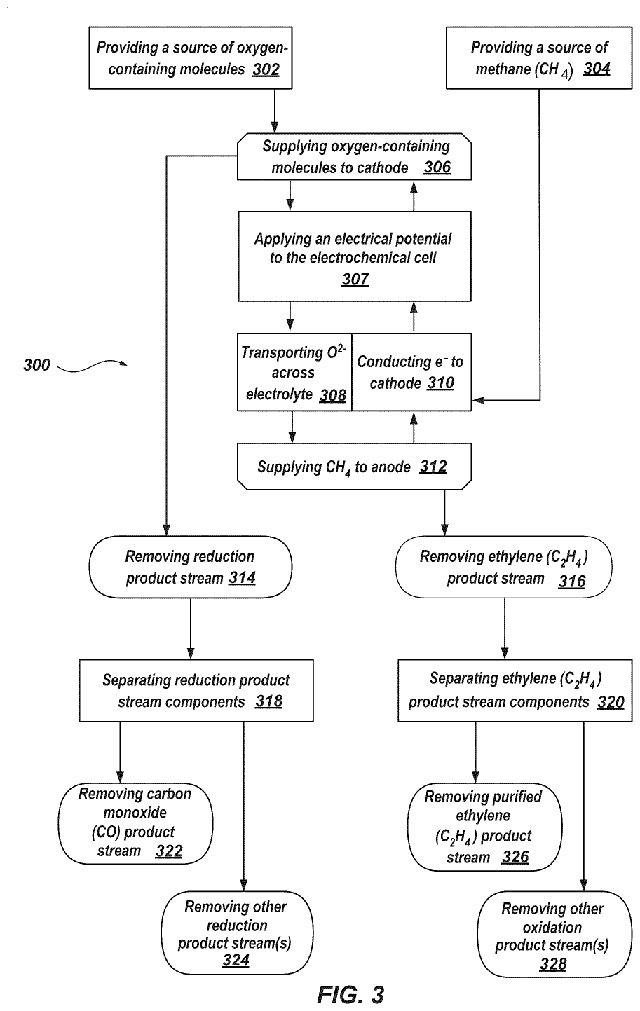

FIG. 3 illustrates a process for producing C₂H₄ according to embodiments of the disclosure. The method includes providing a source of oxygen-containing molecules (e.g., O₂, CO, CO₂, H₂O) 302 and providing a supply of CH₄ to an electrochemical cell (e.g., the electrochemical cells 110, 210) 304. This includes supplying the oxygen-containing molecules to a cathode 306 side of the electrochemical cell and supplying the CH₄ to an anode side electrochemical cell 312. An electrical potential is applied to the electrochemical cell 307, transporting oxygen ions O²⁻ (produced on the cathode side of the electrochemical cell) across the electrolyte 308 and transporting e⁻ from the anode to the cathode 310. The method also includes removing a reduction reaction product stream 314 (e.g., CO, H₂) from the cathode side of the electrochemical cell and removing a C₂H₄ product stream 316 from the anode side of the electrochemical cell. In various embodiments, the method 300 may include separating reduction product stream components 318 of the reduction reaction product stream 314 into separate streams (e.g., removing CO product stream 322 and other product stream(s) 324) for storage, use, or other purposes. Oxygen-containing molecules (e.g., CO₂) in the reduction product stream may be returned to a reactor in which the reactions are conducted. The method may also include separating the C₂H₄ product stream 320 into separate components (e.g., removing purified ethylene stream 326 and other oxidation product stream(s) 328) in one or more processes and/or process units for storage, use, or other purposes. Unreacted alkanes (e.g., CH₄) may be recycled back to the electrochemical cell for processing into C₂H₄.

The electrochemical cells (e.g., the electrochemical cell 110, 210), systems (e.g., the system 100), and methods (e.g., the method 300) of the disclosure enable the formation of ethylene from natural gas (e.g., CH₄) with reduced carbon intensity and upgrading of natural gas to platform chemicals. Thus, ethylene may be formed by decarbonizing the ethylene production. The electrochemical cells, systems, and methods of the disclosure may also reduce one or more of the costs, (e.g., material costs, operational costs) and energy (e.g., thermal energy, electrical energy) utilized to produce ethylene relative to conventional apparatuses, systems, and methods (e.g., thermal catalytic processes) of producing ethylene. The electrochemical cells, systems, and methods of the disclosure may be more efficient, durable, and reliable than conventional apparatuses, conventional systems, and conventional methods of ethylene production. The produced ethylene may be used, for example, to form plastics, resins, methanol, synthetic lubes, or fuels.

The electrochemical cells (e.g., the electrochemical cells 110, 210), systems (e.g., the system 100), and methods (e.g., the method 300) enable the formation of ethylene using distributed oxygen across the entire reactor (or at least over the length of the oxygen permeable zone of the membrane). The reactor may be an electrochemical membrane reactor (EMR). The oxygen partial pressure in the reactor (e.g., in an OCM reaction chamber of the EMR) may be kept low and homogeneous, promoting partial oxidation and not the total oxidation of methane, thus increasing the selectivity to higher hydrocarbon products. In addition, the disclosed methods and apparatus combines two conventional operations units, an oxygen separator to produce O₂ and/or O²⁻ and a chemical reactor for the OCM reaction, into a single operations unit (e.g., the EMR) thus increasing the space-time-yield of C2 products (e.g., ethane, ethylene). Finally, the perovskite structured OCM catalysts are electronically conductive, thus compatible with the OC-SOEC electrode, and can effectively promote electrocatalytic conversion of methane.

The methods and apparatus disclosed herein have been described in connection with OCM reactions. However, in various embodiments, the system may be reversibly operated as an SOEC (i.e., electrolysis mode) or as a solid oxide fuel cell (SOFC) (i.e., fuel cell mode). This may be used to regenerate catalysts and electrodes after long term use in SOEC mode. The polarity of the claimed first and second electrodes depend on the polarity of the electrical potential being applied (e.g., for electrolysis mode or fuel cell mode).

The electrochemical cells (e.g., the electrochemical cell 110, 210), systems (e.g., the system 100), and methods (e.g., the method 300) of the disclosure may enable the production of ethylene from small natural gas reservoirs that are geographically isolated and otherwise would not be economically viable for producing ethylene. The electrochemical cells (e.g., the electrochemical cell 110, 210), systems (e.g., the system 100), and methods of the disclosure may also be used to convert landfill gas, which is a renewable hydrocarbon source, to ethylene.

### EXAMPLES

### Example 1: La₂O₃ Nanorod Catalyst Synthesis

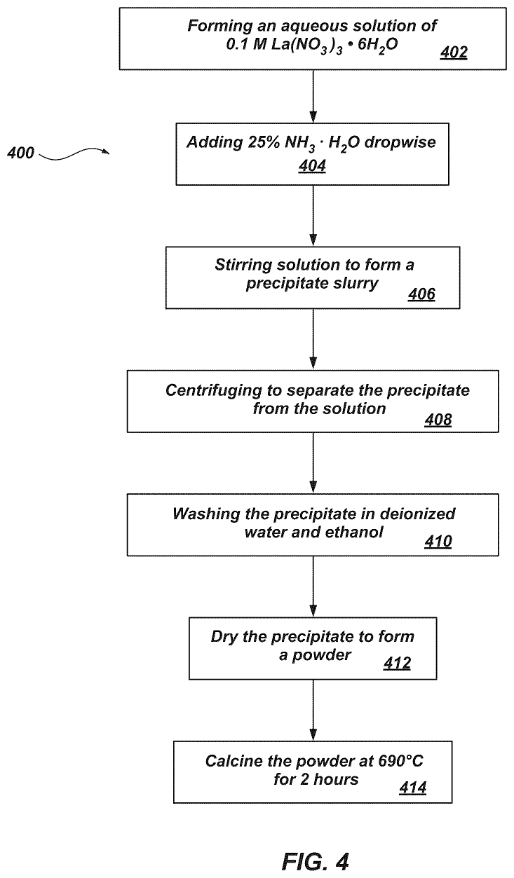

FIG. 4 illustrates a method 400 of forming a La₂O₃ nanorod catalyst. An aqueous solution of 0.1 M La(NO₃)₃·6H₂O was formed 402. 25% NH₃·H₂O was added to 250 mL 0.1 M La(NO₃)₃·6H₂O solution dropwise 404. The resulting solution was stirred vigorously for more than one hour to obtain a slurry including a precipitate 406. The precipitate was separated through centrifugation 408 and washed with deionized water and ethanol several times 410. After drying the precipitate at 90° C. in air overnight to form a powder 412, the powder was calcined at 690° C. for 2 hours in a box furnace to obtain La₂O₃ nanorods 414. The obtained La₂O₃ nanorods had a diameter of less than about 100 nm.

### Example 2: Thermal Catalytic Performance of La₂O₃ Nanorods

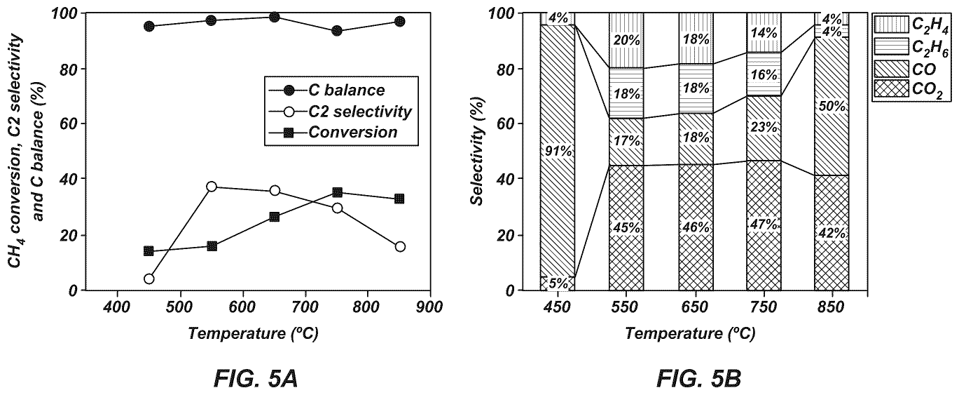

The thermal catalytic performance of the La₂O₃ nanorods, as described in Example 1, in an OCM reaction was evaluated in a fixed bed flow reactor system. FIGS. 5A and 5B are graphical representations of the catalytic performance of the La₂O₃ nanorods as a function of temperature. As shown in FIG. 5A, the CH₄ conversion using the La₂O₃ nanorod catalyst reached about 14% at 450° C., increased with temperature from about 450° C. to about 750° C., and leveled off at higher temperatures. As shown in FIGS. 5A and 5B, the selectivity of C2 products (e.g., C₂H₄, C₂H₆) increased from less than about 5% to about 37.5% as the temperature increased from 450° C. to 550° C. and decreased slightly from about 37.5% at higher temperatures (e.g., 650° C., 750° C., 850° C.). Referring to FIG. 5A, the carbon balance for the OCM reaction was higher than 93% at all analyzed temperatures, indicating negligible carbon deposition occurred during the OCM reaction.

### Example 3: Cell Fabrication

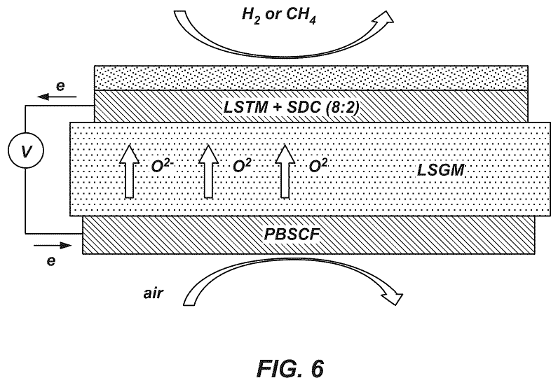

FIG. 6 illustrates a simplified cross-sectional view of an electrolyte-supported single cell (e.g., an electrochemical cell). An LSGM electrolyte was prepared by a tape-casting method and fired (e.g., sintered) at 1450° C. for 5 hours. The LSGM electrolyte had a thickness of about 310 micrometers (μm) and exhibited relatively good mechanical strength. The electrolyte-supported single cell was fabricated by coating PBSCF on one side of the LSGM electrolyte to form a cathode and LSTM-SDC on the other side of the LSGM electrolyte to form an anode. The electrolyte-supported single cell included the PBSCF cathode, the LSGM electrolyte, and the LSTM-SDC anode. La₂O₃ nanorods, as described in Example 1, were loaded on top of the LSTM-SDC electrode.

### Example 4: Electrochemical Performance Evaluations

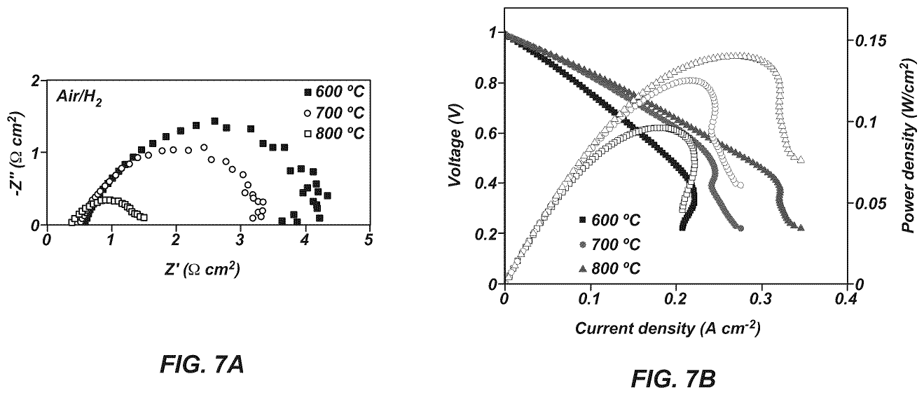

The electrochemical performance of the electrolyte-supported single cell described in Example 3 was evaluated using an H_{2(g)} and air as feed gases at different temperatures. FIG. 7A illustrates a Cole-Cole plot obtained from electrochemical impedance spectroscopy (EIS) measurements, of the electrolyte-supported single cell, as described in Example 4, operated as an electrolysis cell at different temperatures using H₂ and air as the feed gases to the anode and the cathode, respectively, where the x-axis is Z′ and the y-axis is −Z″, where Z′ and Z″ are the real and imaginary parts of the complex impedance, respectively. FIG. 7B illustrates a current density vs. voltage plot (e.g., polarization curve) and a current density vs. power density plot (e.g., power density curve) electrolyte-supported single cell, as described in Example 4, operated as an electrolysis cell at different temperatures using H₂ and air as the feed gases to the anode and the cathode, respectively. As shown in FIG. 7B, the peak power density reached at 800° C. was about 140 mW/cm².

### Example 5: Electrochemical Performance Evaluations

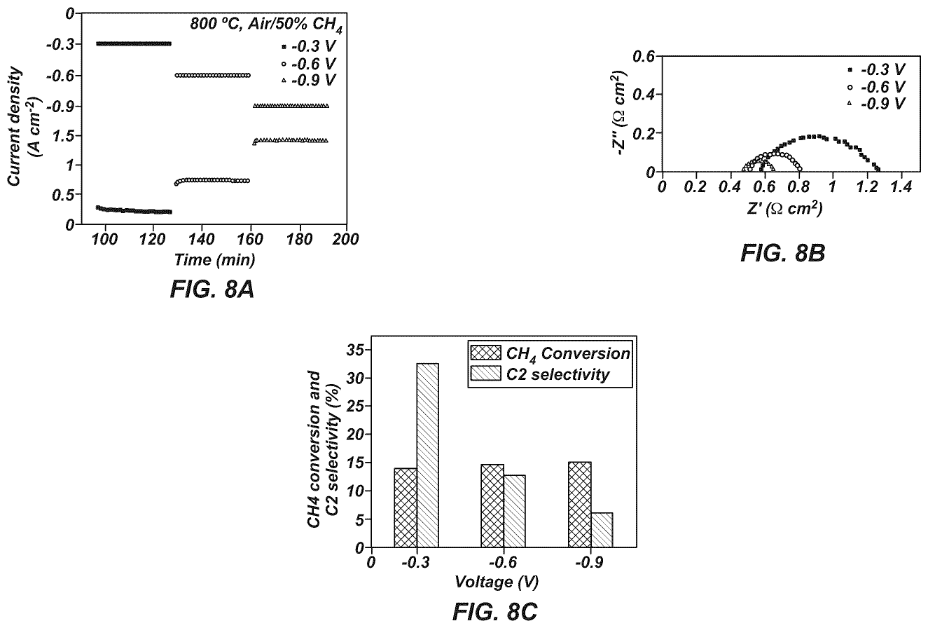

The electrochemical performance of the electrolyte-supported single cell described in Example 3 was evaluated using an CH₄ and air as feedstocks while being operated as an electrolysis cell at 800° C. under different applied voltages. FIG. 8A is a graphical representation of the electrochemical performance of the electrolyte-supported single cell observed during CH₄ oxidation. FIG. 8B is a Cole-Cole plot obtained from EIS measurements, of the electrolyte-supported single cell, as described in Example 4, operated as an electrolysis cell at 800° C. under different applied voltages using CH₄ and air as the feed gases to the anode and the cathode, respectively, where the x-axis is Z′ and the y-axis is −Z″, where Z′ and Z″ are the real and imaginary parts of the complex impedance, respectively. As shown in FIG. 8B, the ohmic resistance Rₒ (shown by the left intercept of the EIS curve with the x-axis) decreased with an increase in applied voltage. FIG. 8C is a graphical representation of CH₄ conversion and C2 product selectivity observed at different voltages. As shown in FIG. 8C, the methane conversion increased with applied voltage, while the C2 selectivity decreased dramatically with an increase in applied voltage.

### Example 6: Cell Fabrication

An LSGM electrolyte was prepared by tape-casting method and fired (e.g., sintered) at 1450° C. for 8 hours. A porous SFMN-SDC composite was coated on both sides of the LSGM electrolyte to form a cathode and an anode. Silver paste was coated on the SFMN-SDC electrodes to serve as current collectors. A La₂O₃ catalyst was coated on one side of the cell over the silver paste current collector and calcined at 1100° C. for 5 hours to form an electrochemical cell. The LSGM electrolyte had a thickness of about 273 μm and the porous SFMN-SDC composite electrodes had a thickness of about 20 μm. The La₂O₃ catalyst had a thickness of about 30 μm.

### Example 7: Electrochemical Performance Evaluations

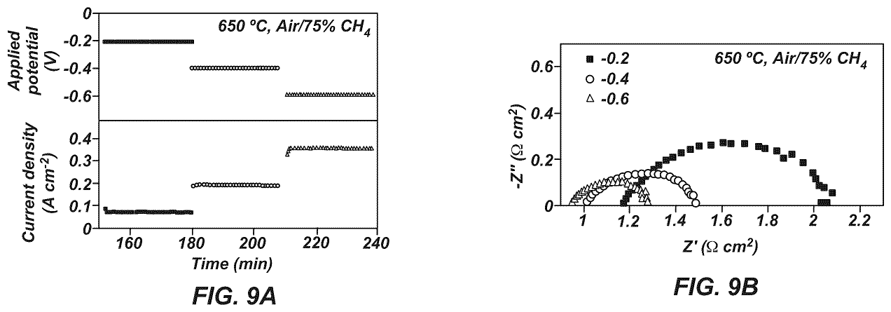

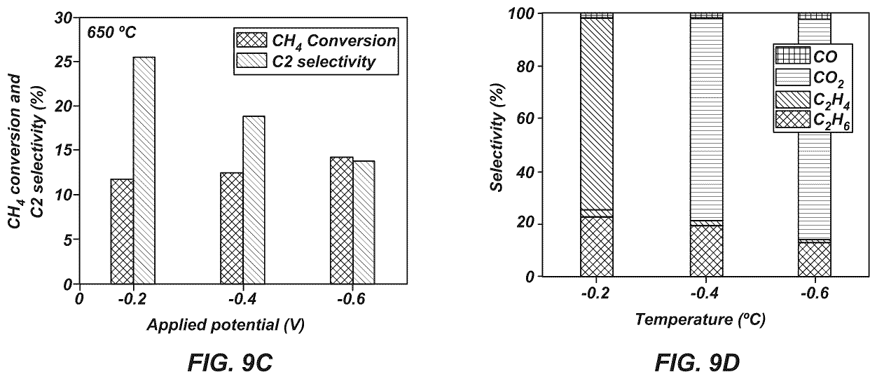

The electrochemical performance of the electrochemical cell described in Example 6 was evaluated using 75% CH₄ and air as feed gases to the anode and the cathode, respectively, at 650° C. FIG. 9A is a graphical representation of the electrochemical performance of the electrolyte-supported single cell observed during CH₄ oxidation. As shown in FIG. 9A, as the applied voltage increased, the corresponding current density increased as well. FIG. 9B is a Cole-Cole plot obtained from EIS measurements, of the electrochemical cell, as described in Example 5, operated as an electrolysis cell at 650° C. under different applied voltages using CH₄ and air as the feed gases to the anode and the cathode, respectively, where the x-axis is Z′ and the y-axis is −Z″, where Z′ and Z″ are the real and imaginary parts of the complex impedance, respectively. As shown in FIG. 9B, the Rₒ decreased with an increase in applied voltage. FIG. 9C is a graphical representation of CH₄ conversion and C2 product selectivity observed at different applied voltages. As shown in FIG. 9C, as the applied voltage increased from −0.2 V to −0.6 V, the CH₄ conversion slightly increased from about 11.8% to about 14.3%, respectively, and the corresponding selectivity of C2 products decreased from 25.2% to 13.8%, respectively. FIG. 9D is a graphical representation of observed product selectivity at different applied voltages. As shown in FIG. 9D, the CO₂ selectivity increased at the expense of C2 product selectivity with an increase in applied voltage.

### Example 8: Perovskite-Structured Mixed Metal Oxide Catalyst Synthesis

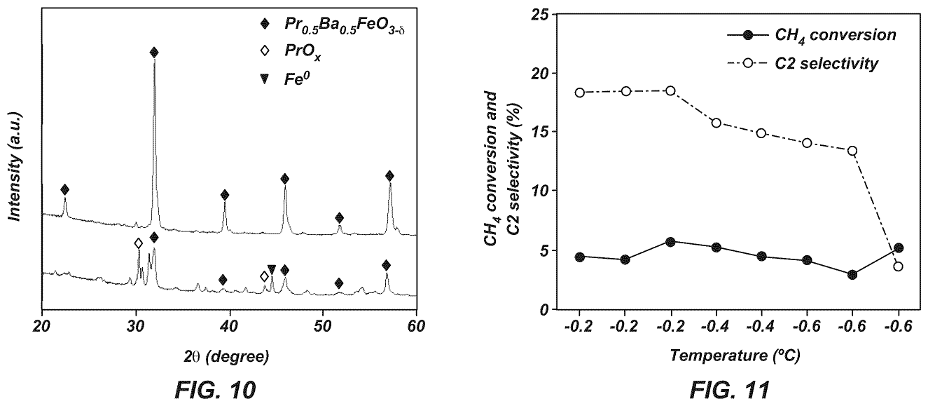

A Pr_{0.5}Ba_{0.5}FeO_{3-δ} (PBF) catalyst was formed. The PBF catalyst was subjected to a reduction treatment at 860° C. for 2 hours. FIG. 10 illustrates X-ray diffraction (XRD) patterns of the PBF catalyst before and after the reduction treatment. As shown in FIG. 9, before the reduction treatment, the PBF catalyst exhibited a simple perovskite phase with negligible secondary phases. After the reduction treatment, the PBF catalyst exhibited the simple perovskite phase and second phases, including praseodymium oxides (PrOₓ) and metallic Fe.

### Example 9: Catalytic Performance Evaluations

The catalytic performance of the reduced PBF catalyst, as described in Example 8, was tested in an OCM reaction under thermal catalytic conditions in a fixed bed flow reactor. FIG. 11 is a graphical representation of CH₄ conversion and C2 selectivity associated with the PBF catalyst at different temperatures. As shown in FIG. 11, the CH₄ conversion remained around 5% from 100° C. to 800° C. The C2 selectivity decreased as the temperature increased from 100° C. to 800° C. Coking was observed in the catalyst bed and on the walls of the reactor due to the presence of metallic Fe.

### Example 10: Perovskite-Structured Mixed Metal Oxide Catalyst Synthesis

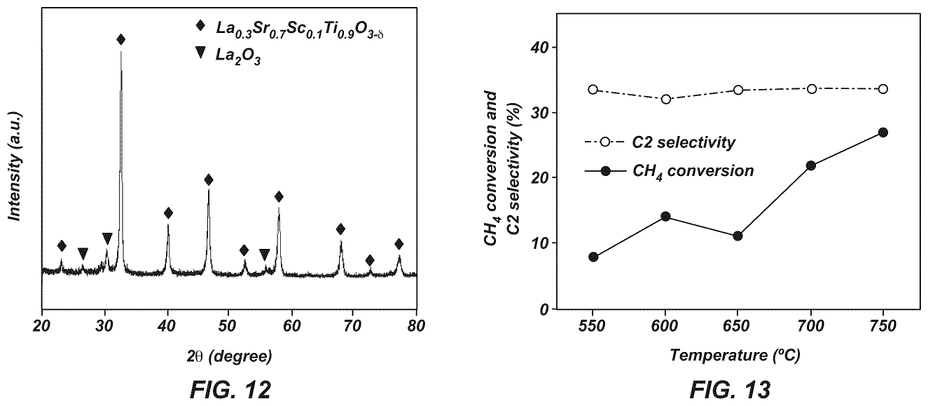

A La_{0.3}Sr_{0.7}Sc_{0.1}Ti_{0.9}O_{3-δ} (LSScT) catalyst was formed. FIG. 12 illustrates an XRD pattern of the LSScT catalyst. As shown in FIG. 11, the LSScT catalyst exhibited a typical perovskite phase structure. La₂O₃ was identified as a second phase included in the LSScT catalyst.

### Example 11: Catalytic Performance Evaluations

The catalytic performance of the LSScT catalyst, as described in Example 10, was tested in an OCM reaction under thermal catalytic conditions in a fixed bed flow reactor. FIG. 13 is a graphical representation of CH₄ conversion and C2 selectivity associated with the LSScT catalyst at different temperatures. As shown in FIG. 13, the CH₄ conversion increased from about 8% to about 27% as the temperature increased from 500° C. to 750° C. with negligible changes in the C2 selectivity. The C2 selectivity remained about 33% from 500° C. to 750° C.

### Example 12: Perovskite-Structured Mixed Metal Oxide Catalyst Synthesis and Catalytic Performance Evaluations

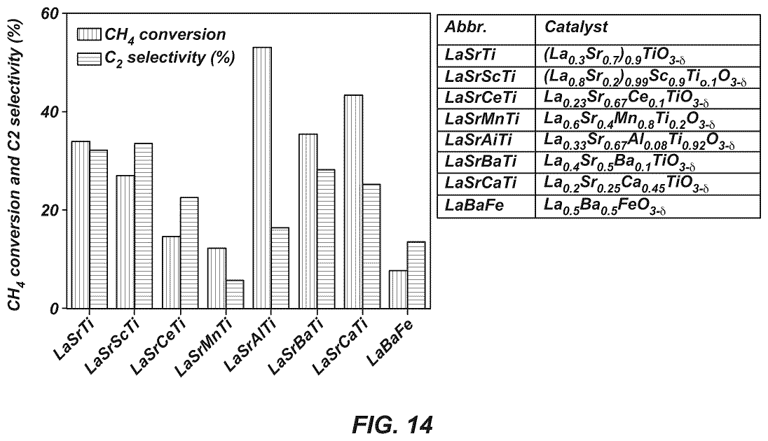

Lanthanum titanate (LaTiO₃) was systematically modified by introduction transition metal ions to the A-site (e.g., Ca, Sr, Ba) and/or the B-site (e.g., Sc, Ce, Mn, Fe) of the perovskite structure. The modified lanthanum titanate is La_{1-y}A_{y}Ti_{1-z}B_{z}O₃ where a is a transition metal dopant (e.g., Ca, Sr, Ba) in the A-site and B is a dopant (e.g., Sc, Ce, Mn, Fe) in the B-site of the perovskite structure and y and z are dopant levels. The modified LaTiO₃ catalysts were tested in an OCM reaction under thermal catalytic conditions in a fixed bed flow reactor. FIG. 14 is a graphical comparison of CH₄ conversion and C2 selectivity associated with each of the modified LaTiO₃ catalysts evaluated at 800° C. As shown in FIG. 14, partially replacing La ions in the A-site with Sr resulted in a relatively high CH₄ conversion of about 34% and a relatively high C2 selectivity of about 32%. Further modifying the composition by adding Ce, Sc, or Mn to the B-site decreased the CH₄ conversion and C2 selectivity. Adding Ba or Ca to the A-site of the Sr-modified LaTiO₃ catalyst and adding A1 to the B-site of the Sr-modified LaTiO₃ catalyst resulted in an increase in CH₄ conversion and a decrease in C2 product selectivity.

### Example 13: Fabrication of Button Cells

A Sr₂FeMo_{0.8}Ni^{0.2}O_{6-δ} (SFMN)-SDC (65:35) composite was used as the anode. The SFMN was synthesized by a combustion method, followed by firing at 1000° C. for 5 h. A benchmark OCM catalyst, La₂O₃ nanorods with a well-defined one-dimensional nanostructure (less than 100 nm), was used as the catalytic layer as a baseline for comparison.

To fabricate the single cells, LSGM pellets were prepared by tape casting and sintered at 1450° C. for 8 hours and coated with SFMN-SDC composite as electrode on both sides. Silver paste was coated on both sides of the cell to serve as the current collector. The SFMN powder was synthesized by a combustion method. The single cell with symmetric configuration SFM-SDC|LSGM|SFM-SDC was prepared by coating SFMN-SDC composite on both side of the pre-sintered dense LSGM electrolyte. Silver paste was coated on both sides of the cell to serve as the current collector. Subsequently, a paste of LSScT catalyst was coated on one side of the symmetrical cell, followed by calcination at 1100° C. for 5 h. The as-obtained cell was sealed on a fixture for electrochemical measurement.

To measure the electrochemical performance, the fabricated button cells were sealed in a reactor using a Ceramabond 552 glass sealant. Silver mesh and platinum wire were used as the current collector and leads, respectively. Electrochemical performance was measured and analyzed using a Solartron 1400 & 1470 (AMETEK Inc.) electrochemical working station.

### Example 14: Performance Evaluation of Catalysts and Button Cells

The thermal catalytic performances of various catalysts were initially evaluated in a fixed-bed tubular flow reactor at different temperatures. One hundred mg of each sample was packed into a fritted reactor with inactive quartz wool to fix the catalyst bed.

The gas compositions at the outlet of the reactor were analyzed using gas chromatography (GC, Shimadzu 2010 plus equipped with TCD and FID detectors) to determine the propane conversion and product selectivity. The selectivity was calculated on a carbon basis, which was derived from the peak area of each major product in the gas mixture.

The conversion of methane, C2 selectivity, and yield of C₂ (i.e., carbon balance) was calculated according to the equations below:

$${X}_{{CH}_{4}} ( \% ) = \frac{{F}_{{CH}_{4} , Feed} - {F}_{{CH}_{4}}}{{F}_{{CH}_{4} , Feed}} \times 100 \qquad ( 3 )$$

$$C 2 selectivity ( \% ) = \frac{2 \times {F}_{C 2}}{{F}_{{CH}_{4}} + 2 \times {F}_{C 2} + 3 \times {F}_{C 3} + {F}_{CO} + {F}_{CO 2}} \times 100 \qquad ( 4 )$$

$$Carbon balance ( \% ) = \frac{{F}_{{CH}_{4}} + 2 \times {F}_{C 2} + 3 \times {F}_{C 3} + {F}_{CO} + {F}_{CO 2}}{{F}_{{CH}_{4} , Feed}} \qquad ( 5 )$$

### Example 15: Catalytic Performance in Fixed Bed Flow Reactor

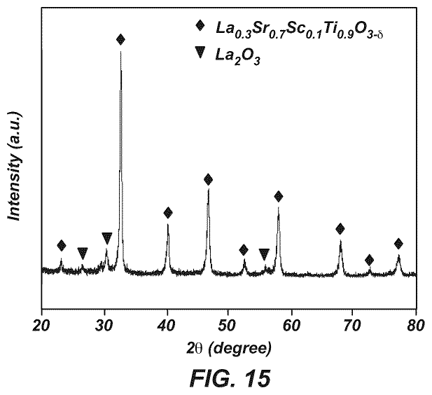

Another type of mixed metal oxide catalysts based on LaTiO₃ perovskite was also synthesized and tested in the OCM reaction. The perovskite phase structure was confirmed by the XRD pattern of an as-prepared La_{0.3}Sr_{0.7}Sc_{0.1}Ti_{0.9}O_{3-δ} (LSScT) catalyst as an example (FIG. 15). A small amount of La₂O₃ secondary phase was also identified, which are believed to act as the active sites for OCM reaction.

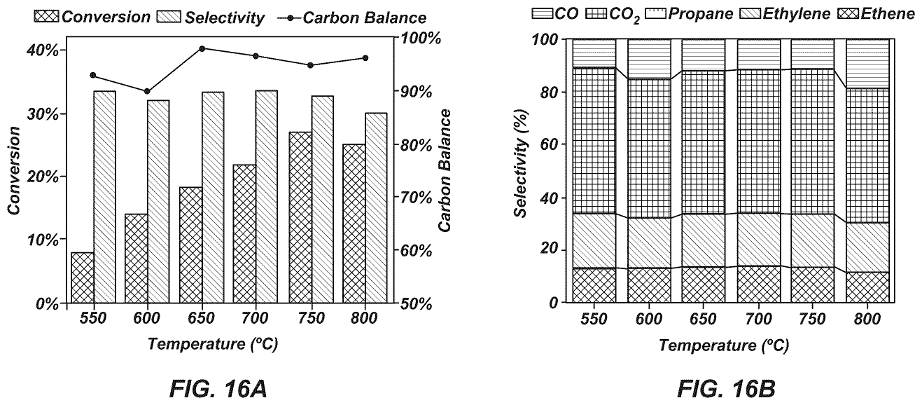

The LSScT catalyst showed good catalytic performance in OCM in terms of both CH₄ conversion and C2 selectivity (FIG. 16). The CH₄ conversion increased from about 8% to about 27% as the temperature increased from 550° C. to 750° C. with negligible changes in the selectivity of C2 products (˜33%).

### Example 16: Effect of Catalyst Integration Method and Applied Current Density on the Catalyst Performance

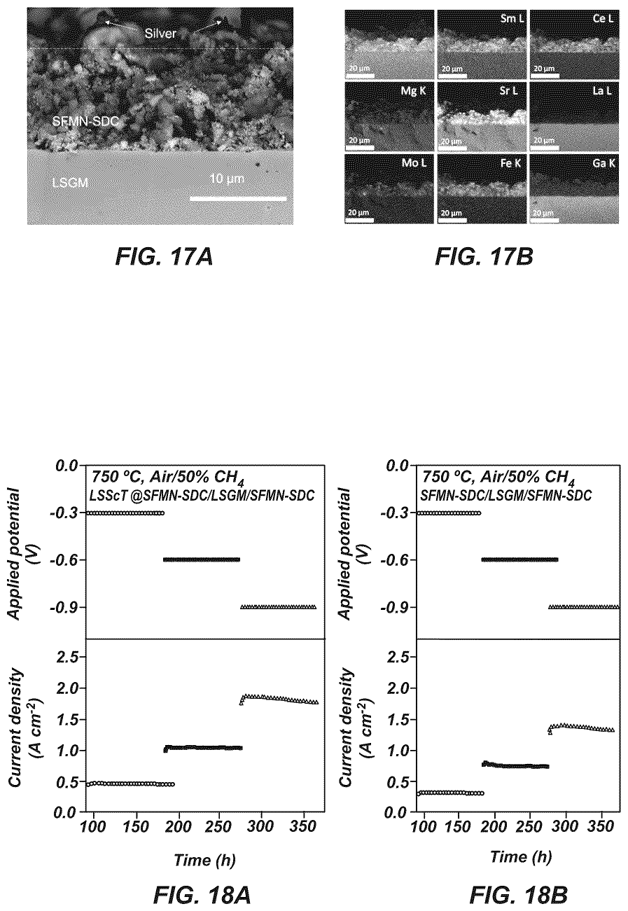

The microstructure of the single cell is shown in FIG. 17. A dense LSGM electrolyte had a thickness of 273 μm and the porous composite SFMN-SDC electrode had a thickness of around 20 μm. The SFMN-SDC had a very porous structure with two phases that can be differentiated from the SEM-EDX results shown in FIG. 17B. The EDX result showed that the elemental distribution is homogeneous after OCM operation for 40 h. No obvious element diffusion or phase reaction was identified.

A symmetrical cell with configuration SFMN-SDC|LSGM|SFMN-SDC with no catalyst coated was also measured under the same conditions for comparison (bare). FIGS. 18A and 18B show the short-term electrochemical performance of CH₄ oxidation at various applied voltages. For the LSScT coated cell (FIG. 18A), as the applied voltage increased from −0.3 V to −0.6 and −0.9 V, the corresponding current density steadily increased from 0.5 A cm⁻² to 1.04 and 1.72 A cm⁻². For comparison, the bare cell (FIG. 18B) exhibited a current density of 0.28 A cm⁻², 0.72 A cm⁻² and 1.3 A cm⁻², under an applied potential of −0.3 V to −0.6 and −0.9 V, respectively. The superior performance of the LSScT sample may stem from its elevated open current voltage (OCV), resulting in a higher potential difference under the applied conditions.

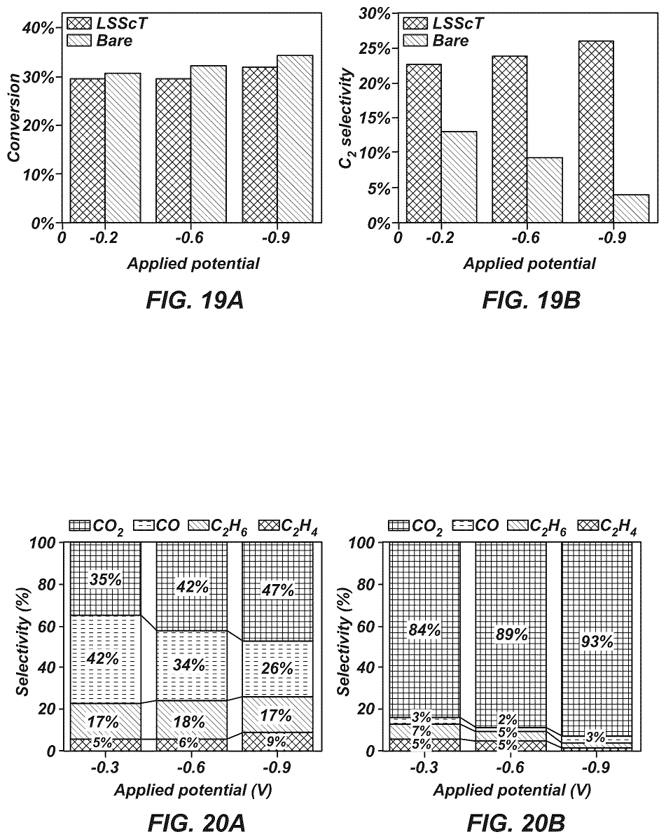

FIGS. 19A and 19B show the catalytic performance in terms of CH₄ conversion and C2 selectivity of the bare and catalyst integrated cell. For LSScT coated cells, as the applied voltage increased from −0.3 V to −0.6 and −0.9 V, the CH₄ conversion slightly increased from 29.4% to 29.7% and 32.0%, respectively. The corresponding selectivity of C2 products increased from 22.6% to 24.0% and 26.0%, respectively. In contrast, bare sample possessed a higher conversion but lower C2 selectivity under the same conditions. The C2 selectivity on the bare cell decreased as the applied potential increased, possibly due to the over-oxidation of CH₄.

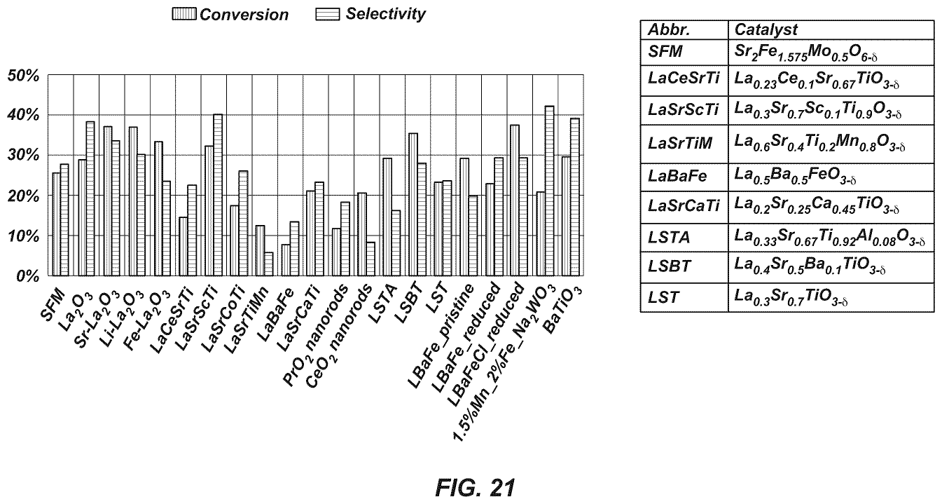

A detailed analysis of the product distribution (FIGS. 20A and 20B) revealed that both C₂H₄ and C₂H₆ selectivity increased while CO and CO₂ selectivity decreased as the potential increased for LSScT coated sample. Nevertheless, the primary product in the bare sample was CO₂, suggesting that the electrochemical process is primarily driven by the direct oxidation of CH₄, with limited catalytic effectiveness. This phenomenon elucidates the decline in C2 electivity as depicted in FIG. 18B with an increase in potential.

### Example 17: Comparison of Conversion and Selectivity for Various Catalysts

FIG. 21 is a graphical comparison of CH₄ conversion and C2 electivity associated with each of the modified LaTiO₃ catalysts evaluated at 800° C. LaSrScTi possesses comparable performance to state-of-the-art La₂O₃ oxides, performance compared to other oxides and perovskite-based materials. As shown in FIG. 21, partially replacing La ions in the A-site with Sr and adding Sc to the B-site resulted in 32.0% conversion of CH₄ and 40.1% selectivity of C2 products.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalent. For example, elements and features disclosed in relation to one embodiment may be combined with elements and features disclosed in relation to other embodiments of the disclosure.

What is claimed is:

1. A method of forming ethylene (C₂H₄), comprising:
introducing oxygen-containing molecules to a first electrode of an electrochemical cell, the electrochemical cell comprising:
the first electrode;
a second electrode comprising at least one catalyst material formulated to accelerate oxidative coupling of methane (CH₄) (OCM) reaction rates to produce C₂H₄ from CH₄ and oxygen ions (O²⁻); and
an electrolyte between the first electrode and the second electrode;
introducing CH₄ to the second electrode of the electrochemical cell; and
applying a potential difference in electrolysis mode between the first electrode and the second electrode of the electrochemical cell, the oxygen-containing molecules interacting with the second electrode to produce O²⁻ through reduction of the oxygen-containing molecules, transporting the O²⁻ through the electrolyte, and producing C₂H₄ at the second electrode through OCM.

2. The method of claim 1, wherein introducing oxygen-containing molecules to a first electrode of an electrochemical cell comprises selecting the oxygen-containing molecules to comprise CO₂ and applying the potential difference between the first electrode and the second electrode of the electrochemical cell while CO₂ interacts with the first electrode to produce CO and O²⁻ through a CO₂ reduction reaction.

3. The method of claim 1, wherein introducing CH₄ to the second electrode of the electrochemical cell comprises introducing natural gas comprising CH₄ and at least one other material to the second electrode.

4. The method of claim 1, wherein introducing oxygen-containing molecules to a first electrode of an electrochemical cell comprises selecting the at least one catalyst material of the second electrode of the electrochemical cell to comprise a lanthanum oxide (La₂O₃)-based material.

5. The method of claim 1, wherein introducing oxygen-containing molecules to a first electrode of an electrochemical cell comprises selecting the at least one catalyst material of the second electrode of the electrochemical cell to comprise a perovskite-structured mixed metal oxide material exhibiting a cubic lattice structure with a chemical formula ABO_{3-δ}, where A comprises one or more of lanthanum (La), praseodymium (Pr), cerium (Ce), barium (Ba), strontium (Sr), and calcium (Ca), B comprises one or more of aluminum (Al), titanium (Ti), manganese (Mn), iron (Fe), and scandium (Sc), and 6 is an oxygen deficit.

6. The method of claim 1, wherein introducing oxygen-containing molecules to a first electrode of an electrochemical cell comprises selecting the at least one catalyst material of the second electrode of the electrochemical cell to comprise nanorods.

7. An electrochemical cell, comprising:
a first electrode formulated to facilitate a reduction reaction to produce oxygen ions (O²⁻) from an oxygen-containing molecule;
a second electrode formulated to facilitate oxidative coupling of methane (CH₄) (OCM) to produce ethylene (C₂H₄) from CH₄ and the O²⁻, the second electrode comprising at least one catalyst material comprising one or more of La, Pr, and Ce and formulated to accelerate the OCM to produce the C₂H₄ from CH₄ and the O²⁻; and
an electrolyte between the first electrode and the second electrode.

8. The electrochemical cell of claim 7, wherein the at least one catalyst material comprises one or more of La₂O₃, PrO₂, and CeO₂.

9. The electrochemical cell of claim 7, wherein the at least one catalyst material comprises a perovskite-structured mixed metal oxide material exhibiting a cubic lattice structure with a general formula ABO_{3-δ}, where A comprises one or more of lanthanum (La), praseodymium (Pr), cerium (Ce), barium (Ba), strontium (Sr), and calcium (Ca), B comprises one or more of aluminum (Al), titanium (Ti), manganese (Mn), iron (Fe), and scandium (Sc), and δ is an oxygen deficit.

10. The electrochemical cell of claim 7, wherein the at least one catalyst material comprises a nanostructured material.

11. The electrochemical cell of claim 7, wherein the at least one catalyst material comprises nanorods.

12. The electrochemical cell of claim 11, wherein the electrolyte comprises an O²⁻ conducting material.

13. A system for producing ethylene (C₂H₄) from oxidative coupling of methane (CH₄) (OCM), comprising:
an electrochemical apparatus in fluid communication with a source of oxygen-containing molecules and a source of CH₄, and comprising:
a housing structure configured to receive an oxygen-containing molecule stream from the source of oxygen-containing molecules and to receive a CH₄ stream from the source of CH₄;
one or more electrochemical cells within an internal chamber of the housing structure, and comprising:
a first electrode formulated to facilitate a reduction reaction to produce oxygen ions (O²⁻) from an oxygen-containing molecule;
a second electrode comprising at least one catalyst material formulated to accelerate an OCM reaction rate to produce C₂H₄ from CH₄ and the oxygen ions (O²⁻); and
an electrolyte between the first electrode and the second electrode; and
a power source configured to apply a potential difference between the first electrode and the second electrode.

14. The system of claim 13, wherein the housing structure further comprises:
a first chamber containing the second electrode and in fluid communication with the source of CH₄; and
a second chamber containing the first electrode and in fluid communication with the source of oxygen-containing molecules.

15. The system of claim 13, wherein the oxygen-containing molecules comprise carbon dioxide (CO₂).

16. The system of claim 13, wherein the at least one catalyst material comprises a perovskite-structured mixed metal oxide material exhibiting a cubic lattice structure with a chemical formula ABO_{3-δ}, where A comprises one or more of lanthanum (La), praseodymium (Pr), cerium (Ce), barium (Ba), strontium (Sr), and calcium (Ca), B comprises one or more of aluminum (Al), titanium (Ti), manganese (Mn), iron (Fe), and scandium (Sc), and δ is an oxygen deficit.

17. The system of claim 13, wherein the first electrode comprises one or more of lanthanum oxide (La₂O₃), praseodymium oxide (PrO₂), or cerium oxide (CeO₂).

18. The system of claim 13, wherein the electrolyte comprises a yttria-stabilized zirconia (YSZ) material, a scandia-stabilized zirconia (ScSZ) material, a lanthanum gallate (LaGaO₃) material, a ytterbium-stabilized zirconia (YbSZ) material, a ceria (CeO₂) material, samaria-doped CeO₂ (SDC), a bismuth oxide (Bi₂O₃) material, a yttria-stabilized bismuth oxide (YSB) material, or a thorium dioxide (ThO₂) material.

19. The system of claim 13, wherein the second electrode comprises a ceramic material comprising a ytterbium-stabilized zirconate (YSZ) material, a scandia-stabilized zirconia (ScSZ) material, or lanthanum gallate (LaGaO₃).

20. The system of claim 13, wherein the second electrode comprises a cermet material comprising gadolinia-doped CeO₂ (GDC) or samaria-doped ceria (SDC) and one or more of Sr₂FeMo_{0.8}Ni_{0.2}O_{6-δ} (SMFN and Sr₂Fe_{1.5}Mo_{0.5}O_{6-δ} (SFM) where δ is an oxygen deficit.
